(19) United States
(12) Patent Application Publication
(10) Pub. No.: US 2012/0174394 A1
(43) Pub. Date: Jul. 12, 2012

(54) METHOD FOR MANUFACTURING MULTILAYER CIRCUIT BOARD

(75) Inventors: Tae-Eun CHANG, Gyeonggi-do (KR); Sukwon Lee, Gyeonggi-do (KR); Francis Sohn, Gyeonggi-do (KR); Changgun Oh, Daejeon-si (KR)

(73) Assignee: Samsung Electro Mechanics Co., Ltd., Suwon (KR)

(21) Appl. No.: 13/346,278

(22) Filed: Jan. 9, 2012

(30) Foreign Application Priority Data
Jan. 11, 2011 (KR) 10-2011-0002648

(51) Int. Cl. H01K 3/10

(52) U.S. Cl. 29/852

(57) ABSTRACT

Disclosed herein is a method for manufacturing a multilayer circuit board, and more particularly, is a method for manufacturing a coreless multilayer circuit board that forms a support including a separating layer made of a thermoplastic resin and allowing the support to be simply separated, thereby being advantageous in processing a subsequent process, regardless of a size of the board, and economical in the manufacturing process of the support and the manufacturing costs thereof.

### CROSS REFERENCE(S) TO RELATED APPLICATIONS

This application claims the benefit under 35 U.S.C. Section 119 of Korean Patent Application Serial No. 10-2011-0002648, entitled “Method For Manufacturing Multilayer Circuit Board” filed on Jan. 11, 2011, which is hereby incorporated by reference in its entirety into this application.

### BACKGROUND OF THE INVENTION

1. Technical Field

The present invention relates to a method for manufacturing a multilayer circuit board, and more particularly, to a method for manufacturing a coreless multilayer circuit board that forms a support including a separating layer made of a thermoplastic resin and allowing the support to be simply separated, thereby being advantageous in processing a subsequent process, regardless of a size of the board, and economical in the manufacturing process of the support and the manufacturing costs thereof.

2. Description of the Related Art

In accordance with the recent trend of miniaturizing electronic products, the size of components included in the electronic products has been decreasing.

Therefore, the size of a package in which a device chip of the electronic product has also decreased, such that there is a demand for miniaturizing a board included in the package.

Meanwhile, a thin thickness of the board becomes an important factor in order to minimize a loop inductance that is dependent on a physical distance of a circuit. In particular, there is a more increasing demand for developing a multilayer circuit board for a thin and fine semiconductor device in a semiconductor field, in which miniaturization is essentially required.

However, a multilayer circuit board having a thin thickness, which is being currently developed, is disadvantageous in view of a complicated manufacturing process thereof, high manufacturing costs, and degradation in reliability of a product.

In particular, a careless method that removes a core, which occupies the largest portion of the multilayer circuit board, has been actively developed. The key point of the coreless method is to form a circuit over a thin copper clad laminate (CCL), a copper (Cu) thin film, and a solder resist using carriers. A support (carrier) 100 shown in FIG. 1 is used in a method for manufacturing a coreless multilayer circuit board according to the related art.

As shown in FIG. 1, the support 100 according to the related art is configured to include Cu substrates 30 allowing the support to be rigid and a circuit to be formed over an outermost layer thereof, a build-up insulating material 10 such as polypropylene glycol (PPG), an ajinomoto build-up film (ABF), or the like positioned between the Cu substrates 30, and releasing films 20 positioned therebetween. After the process of a circuit board has been progressed, a size of the circuit board is decreased while separating and removing the support, which influences a subsequent process.

Therefore, there is a demand for a method for manufacturing a multilayer circuit board, which is not influenced by the size of the board and does not influence a subsequent process, after a separating process, and is economical in the number of manufacturing processes of the support and the manufacturing costs thereof.

### SUMMARY OF THE INVENTION

An object of the present invention is to provide a method for manufacturing a multilayer circuit board.

According to an exemplary embodiment of the present invention, there is provided a method for manufacturing a multilayer circuit board, the method including: forming a support including a releasable separating layer; forming an insulating part on the support so as to cover the support; forming a via hole in the insulating part and performing a pattern plating thereon; and separating the support by applying heat to the separating layer.

The releasable separating layer may include a thermoplastic resin.

The support may include at least two copper layers.

The support may include a plurality of copper clad laminates.

The insulating part may include a plurality of unit insulating layers.

### BRIEF DESCRIPTION OF THE DRAWINGS

FIG. 1 is a cross-sectional view of a support used in a method for manufacturing a coreless multilayer circuit board according to the related art;

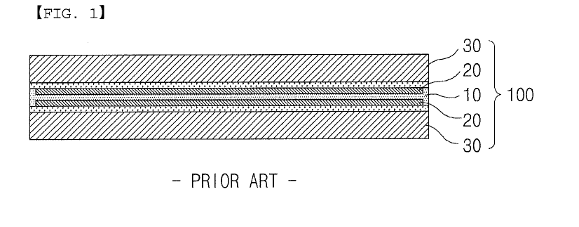

FIG. 2 is a flow chart showing each process of a method for manufacturing a multilayer circuit board according to an exemplary embodiment of the present invention;

FIGS. 3 and 4 are cross-sectional views of a support used in a method for manufacturing a multilayer circuit board according to an exemplary embodiment of the present invention; and

FIGS. 5 to 7 are cross-sectional views showing each process of a method for manufacturing a multilayer circuit board according to an exemplary embodiment of the present invention.

### DESCRIPTION OF THE PREFERRED EMBODIMENTS

Hereinafter, exemplary embodiments will be described in detail with reference to the accompanying drawings so that they can be easily practiced by those skilled in the art to which the present invention pertains.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

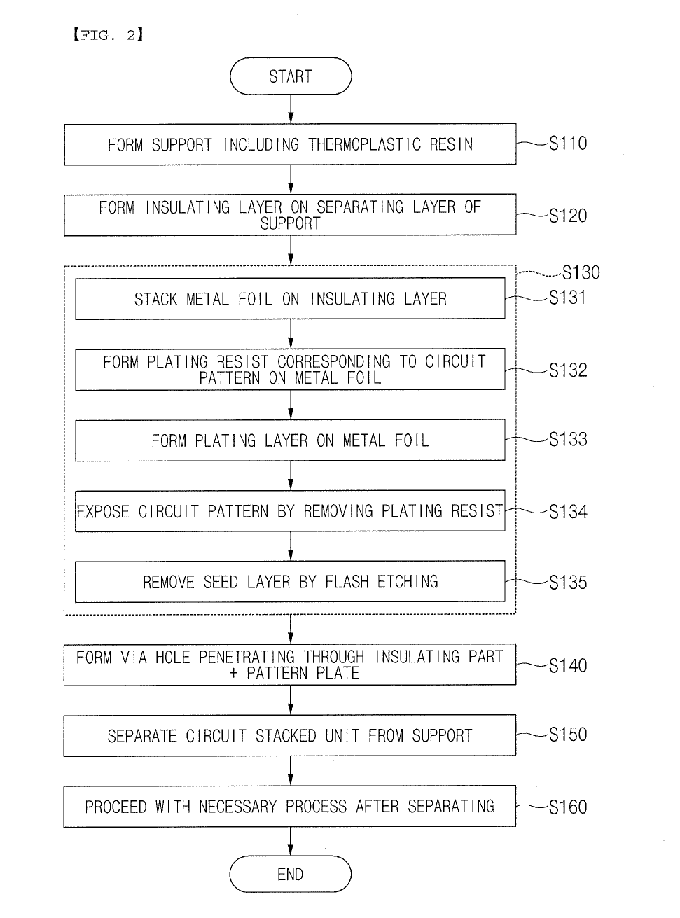

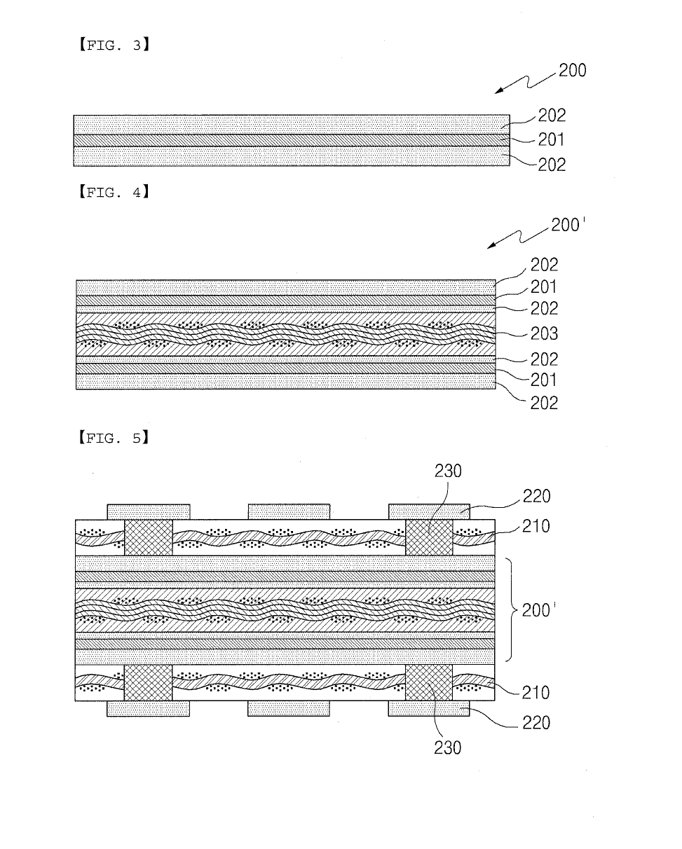

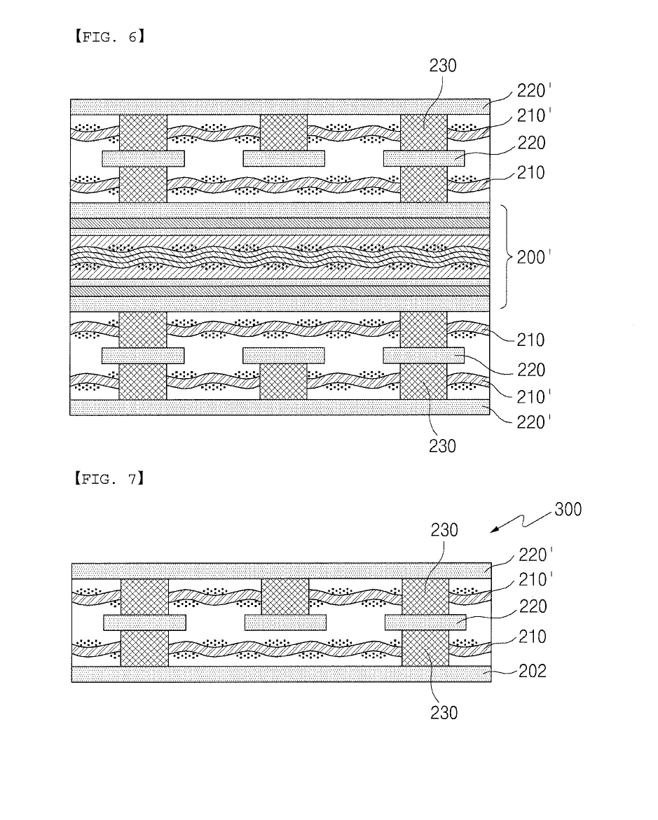

FIG. 2 is a flow chart showing each process of a method for manufacturing a multilayer circuit board according to an exemplary embodiment of the present invention; FIGS. 3 and 4 are cross-sectional views of a support used in a method for manufacturing a multilayer circuit board according to an exemplary embodiment of the present invention; and FIGS. 5 to 7 are cross-sectional views showing each process of a method for manufacturing a multilayer circuit board according to an exemplary embodiment of the present invention.

With the method for manufacturing a multilayer circuit board according to an exemplary embodiment of the present invention, a support 200 in which copper thin layers 202 are symmetrically formed over both surfaces of a thermoplastic resin 201 as shown in FIG. 3 and a support 200′ in which the supports 200 are symmetrically formed over both surfaces of a copper clad laminate 203 as shown in FIG. 4 are provided as a basic unit. Thereafter, all of the operations of manufacturing a multilayer board may be symmetrically performed over both surfaces of the supports 200 and 200′ based on the supports 200 and 200′.

In addition, it is obvious for those skilled in the art to which the present invention pertains that operations of manufacturing the multilayer board such as forming a solder resist layer on one surface of the supports 200 and 200′ (230) and forming a circuit layer 240 thereon may be performed only on one surface of the supports 200 and 200′.

FIGS. 5 to 7 will describe an embodiment in which a manufacturing process of the multilayer substrate is symmetrically performed over both surfaces of the support 200′ based on the support 200′ including a copper clad laminate among the supports 200 and 200′. Therefore, it is to be noted that the method for manufacturing a multilayer circuit board explained in the present specification is symmetrically performed over both surfaces of the support 200′ based on the support 200′ shown in FIG. 4, unless explicitly described.

With the method for manufacturing a multilayer circuit board according to the exemplary embodiment of the present invention, supports 200 and 200′ including a thermoplastic resin are first formed as shown in FIGS. 3 and 4 (S110). The supports 200 and 200′ are manufactured by symmetrically forming copper thin films 202 over both surfaces of the thermoplastic resin 201 or symmetrically forming the support 200 over both surfaces of the copper clad laminate 203. The supports 200 and 200′ become a basement on which a multilayer substrate is formed and serve to support intermediate products for forming the board during a transferring process of each process equipment. The transferring process is made using the supports 200 and 200′, such that the supports 200 and 200′ may be called carriers. The supports 200 and 200′ according to the exemplary embodiment may be configured to include the thermoplastic resin, the copper thin film, and the copper clad laminate. In this case, the copper thin film and the copper clad laminate are adopted to allow the supports 200 and 200′ to be rigid and a circuit to be formed thereon. The supports 200 and 200′ may be made of various materials within a range of the object of the present invention.

As shown in FIGS. 3 and 4, the supports 200 and 200′ may have a separating layer 201 made of a thermoplastic resin. The separating layer 201 is originally made of a material capable of giving release force; however, in the present invention, the separating layer 201 is made of the thermoplastic resin having heat-resistance and chemical-resistance, of which viscosity is gradually decreased according to temperature or is instantly decomposed at a predetermined temperature or more. That is, the thermoplastic resin having characteristics that is stable during a process but is easily decomposable at a predetermined temperature or more due to decrease in viscosity or decomposition may be used in forming the separating layer 201, regardless of the kind thereof. In particular, as the separating layer 201, an acetate polymer, an olefin polymer, a rubber-type polymer, or a mixture thereof may be used. In the case of the acetate based polymer, a cellulose acetate, a vinyl acetate or the like may be used and in the case of the rubber type polymer, a styrene rubber polymer, a butyl rubber polymer, an ethylene propylene diene monomer (EPDM) rubber polymer or the like may be used.

Then, as shown in FIG. 5, an insulating layer 210 is formed over the top surface of the Cu layer of the support 200′ so as to cover the support 200′ (S120). According to the present embodiment, the insulating layer may be made of any materials having insulation property, without limitation thereto, and be preferably made of polypropylene glycol (PPG), an ajinomoto build-up film (ABF) or the like.

As described above, after the insulating layer 210 is formed, a circuit layer 220 is formed over the insulating layer 210, as shown in FIG. 5 (S130). According to the present embodiment, the circuit layer 220 may be a thin copper layer. The circuit layer 220 is made by forming a circuit pattern on a metal foil, that is, a copper foil. According to the present embodiment, the circuit layer 220 may be formed by the following five operations (S131 to S135).

First, a metal foil is stacked on the insulating layer 210 (S131). In this case, the metal foil may be stacked to be opposite to a surface of the insulating layer 210, the surface having roughness formed therein. The reason for this is to secure adhesion between the insulating layer 210 and the metal foil.

Then, a circuit pattern is formed on the metal foil and to this end, a plating resist corresponding to the circuit pattern is first formed on the metal foil (S132). That is, the plating resist is formed in portions, except for a portion in which the circuit pattern is to be formed. As described above, the plating resist formed in the portions, except for the portion in which the circuit pattern is to be formed, may allow a plating layer to be formed in the portion in which the circuit pattern is to be formed.

Then, a plating layer is formed on the metal foil formed with the plating resist (S133). According to the present embodiment, the plating layer may be formed by electroplating the metal foil using an electrode. As described above, the plating layer is formed on the portions, except for the portion in which the plating resist is formed, thereby forming the circuit pattern.

Then, the plating resist is removed (S134). When the plating resist is removed, the circuit pattern formed by the plating layer is exposed. In this case, as the plating resist is removed, the metal foil as well as the circuit pattern are exposed to the outside. Therefore, the exposed metal foil is flash etched to be removed (S315). The flash etching, one of the etching processes, is obvious to those skilled in the art to which the present invention pertains and thus a detailed description thereof will be omitted.

Then, a via hole 230 penetrating through an insulating part 270 may be formed and be pattern plated, as shown in FIG. 5 (S140). The via hole 230 is for an interlayer connection, and a process for forming the via hole 230 is obvious to those skilled in the art to which the present invention pertains and thus a detailed description thereof will be omitted. According to the present embodiment, the insulating layer 210 may include at least one unit insulating layer, wherein the circuit layer may be formed over each unit insulating layer or the via hole 230 penetrating through each unit insulating layer may be formed therein.

After the insulating layer 210 is formed as described above, the operations S120, S130, and S140 are repeated depending on the number of layers, thereby completing a desired layer, as shown in FIG. 6.

In this case, the copper layer 202, the insulating layer 210, the circuit layer 220, and the via hole 230 are collectively named a circuit stacked unit 300. Referring to FIG. 7, the circuit stacked unit 300 is separated from the support 200 by applying heat to the separating layer 201 made of a thermoplastic resin (S150). As described above, the separating layer 201 is made of the thermoplastic material having release force when heat is applied, such that the circuit stacked unit 300 may be easily separated from the support 200.

All operations of the method for manufacturing a multilayer circuit board according to the present embodiment are symmetrically performed on both surfaces of the support 200 based on the support 200, such that two multilayer circuit boards may be obtained after the separating operation. When the manufacturing process of the multilayer circuit board is performed on only one surface of the support 200, a single multilayer circuit board may be obtained, which is obvious to those skilled in the art to which the present invention pertains.

Then, a solder resist layer, which is the outermost layer, is formed over the insulating layer according to a general build-up process.

The solder resist may be a film-type solder resist (SR), a liquid-type solder resist, or a dry film solder resist (DFSR). The solder resist layer may be made of insulating materials having any shape, such as polyimide, FR4, ajinomoto build up film (ABF), bismaleimide-triazine (BT), poly-tetrafluoroethylene (PTFE), liquid crystal polymer (LCP), or the like. According to the present embodiment, the solder resist layer is formed, such that the multilayer circuit board has symmetry to thereby obtain reduction in warpage of the circuit board and packaging reliability thereof.

Then, the solder resist layer is subjected to a laser direct ablation (LDA) process and a solder bumping process, thereby completing the multilayer circuit board for packaging.

With a method for manufacturing a multilayer circuit board according to exemplary embodiments of the present invention, a support is simply separated, thereby being advantageous in processing a subsequent process, regardless of a size of the board, and economical in the manufacturing process of the support and the manufacturing costs thereof.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A method for manufacturing a multilayer circuit board, the method comprising:
forming a support including a releasable separating layer;
forming an insulating part on the support so as to cover the support;
forming a via hole in the insulating part and performing a pattern plating thereon; and
separating the support by applying heat to the separating layer.

2. The method according to claim 1, wherein the releasable separating layer includes a thermoplastic resin.

3. The method according to claim 1, wherein the support includes at least two copper layers.

4. The method according to claim 1, wherein the support includes a plurality of copper clad laminates.

5. The method according to claim 1, wherein the insulating part includes a plurality of unit insulating layers.
